(19) United States
(12) Patent Application Publication
(10) Pub. No.: US 2011/0100900 A1
(43) Pub. Date: May 5, 2011

(54) Monolith Membrane Module for Liquid Filtration

(76) Inventors: Kenneth Joseph Drury, Big Flats, NY (US); Yunfeng Gu, Painted Post, NY (US); Wei Liu, Richland, WA (US)

(21) Appl. No.: 12/989,469

(22) PCT Filed: Apr. 28, 2009
(86) PCT No.: PCT/US09/02587

§ 371 Date: Dec. 7, 2010

Related U.S. Application Data
(60) Provisional application No. 61/125,707, filed on Apr. 28, 2008.

(51) Int. Cl. B01D 63/06

(52) U.S. Cl. 210/490

(57) ABSTRACT

A monolithic multi-channel substrate having a porous monolithic body or cross-flow filtration module defining a plurality of flow channels disposed in the body and extending from an upstream inlet or feed end to a downstream outlet or exhaust end. Porous channel walls surround each of the plurality of flow channels. The plurality of flow channels have a channel hydraulic diameter less than or equal to 1.1 mm. The porous body further comprises a networked pore structure of interconnected pores forming torturous fluid paths or conduits. The tortuous paths formed by the porous body provide a flow path for directing filtrate separated from a process stream to an exterior surface of the body.

### CROSS REFERENCE TO RELATED APPLICATION

This application claims the benefit of U.S. Provisional Application Ser. No. 61/125,707 filed Apr. 28, 2008 and entitled “Monolith Membrane Module for Liquid Filtration”.

### FIELD

The disclosure relates to a cross-flow filtration device for liquid filtration and, more particularly, to an improved cross-flow filtration device for separating a feed stock into a filtrate and a retentate.

### BACKGROUND

Ceramic monolithic multi-channel substrates have been used to filter liquid, to remove particulate contaminants, to separate oily contaminants from aqueous solutions, and to separate and filter industrial liquid streams (see, for example, U.S. Pat. Nos. 4,983,423, 5,009,781, 5,106,502, 5,114,581, and 5,108,601). These substrates may be cross-flow filtration devices which separate a feed stock into filtrate and retentate. A feed stock passing through a monolith having passageways extending from a feed end and a retentate end may flow through the passageways, or may pass through the substrate into a filtrate collection zone and exit the substrate as a filtrate.

### SUMMARY

There exists a need to improve the performance of ceramic monolithic multi-channel substrates by increasing the capacity and efficiency of the filtration substrate or increasing the flux of liquid that may pass through the substrate. In embodiments of the present invention, surprisingly, by reducing the channel size of the passageways in a cross-flow device, the flux increases, improving the performance of the device.

Embodiments provide a monolithic multi-channel substrate 10 having a porous monolithic body or module 150 defining a plurality of flow channels 110 disposed in the body and extending longitudinally from an upstream inlet or feed end 1101 to a downstream outlet or exhaust end 1102 for filtering fluids. Porous channel walls 114 surround each of the plurality of flow channels 110. The porous body 150 further comprises a networked pore structure of interconnected pores forming torturous fluid paths or conduits 152. The tortuous paths 152 formed by the porous body 150 provide a flow path to allow a filtrate, separated from a feed stock, to flow through the fluid paths or conduits formed by the interconnecting pores of the porous material, to an exterior surface of the substrate for collection in a filtrate collector. This filtrate, which flows through the porous substrate, is separated from a retentate fluid stream which flows from an upstream or end face, through flow channels to a downstream or retentate end to be collected in a retentate collector, separate from a filtrate collector.

In use, the plurality of flow channels can receive an impure process or feed stream and the porous channel walls can separate at least a portion of the received process stream into a filtrate and a retentate whereby the separated filtrate is directed through the networked pore structure to an exterior surface of the body. The experimental monolithic multi-channel substrate, as exemplified in the following description, can be used for liquid-phase separation, in laboratory scale or in commercial scale, for extraction of one or more components from a fluid process stream.

In embodiments, the experimental cross-flow filtration device comprises a porous monolithic substrate defining a plurality of flow channels bounded by porous channel walls and extending longitudinally from an upstream inlet end to a downstream outlet end through which a portion of the process stream flows, wherein the plurality of flow channels have a cross sectional area (CSA), a cross sectional perimeter (CSP), and a hydraulic diameter Dₕ less than or equal to 1.1 mm, where Dₕ=4[(CSA)/(CSP)]. A membrane can be deposited on at least a portion of the plurality of porous flow channel walls. The membrane may be porous. According to some embodiments, the porous monolithic substrate has an aspect ratio of greater than 1.0, wherein the aspect ratio is defined as the ratio of module length 104 to part diameter 102. In still other embodiments, the porous monolithic substrate does not define a discrete conduit for receiving a purge stream.

In alternative embodiments, the cross-flow filtration device comprises a porous monolithic substrate defining a plurality of flow channels bounded by porous channel walls and extending longitudinally from an upstream inlet end to a downstream outlet end through which a portion of the process stream flows, wherein the plurality of flow channels have a cross sectional area (CSA), a cross sectional perimeter (CSP), and a hydraulic diameter Dₕ less than or equal to 1.10 mm, where Dₕ=4[(CSA)/(CSP)]. Once again, a porous membrane can be deposited on at least a portion of the plurality of porous flow channel walls. According to these embodiments, the porous monolithic substrate has an aspect ratio greater than 1.0. In an embodiment the porous monolith substrate contains one or more filtrate conduits 190 for permeate removal from the structure. In this embodiment, the porous monolithic substrate does not define a discrete conduit for receiving a purge stream.

Among several advantages, use of embodiments of the small-sized flow channel device having channel hydraulic diameter less than or equal to 1.8 mm, less than or equal to 1.5 mm, less than or equal to 1.25 mm, less than or equal than or equal to 1.1 mm, or less than or equal to 1.0 mm, can facilitate an increase in the surface area packing density of the module. Additionally, it was surprisingly and unexpectedly discovered, as exemplified in the following detailed description and subsequent examples, that reducing the channel size not only enhances the surface area packing density but also substantially increases permeation flux. This increase in permeation flux can be translated to a substantial increase in the filtration throughput represented by the permeation rate per unit volume of the cross-flow filtration device, and represents an increase in the efficiency of the cross-flow filtration device.

Additional embodiments and advantages of the disclosure will be set forth, in part, in the detailed description, and any claims which follow, or can be learned by practice of the disclosure. The foregoing general description and the following detailed description are exemplary and explanatory only and are not restrictive.

### BRIEF DESCRIPTION OF THE DRAWINGS

The accompanying drawings illustrate certain embodiments of the disclosure.

FIG. 1 is a perspective view of an exemplary cross-flow filtration device 150 according to the disclosure.

FIG. 2a is a perspective view of an exemplary monolithic body according to the disclosure further having a plurality of filtrate conduits 190 formed therein.

FIG. 2b is a cross-sectional view of the monolith body shown in FIG. 2a, taken at plane b-b shown in FIG. 2a.

FIG. 3 is a schematic illustration of a cross-flow filtration process utilized in the filtration tests of Example 3.

FIG. 4 is a graph illustration of filtration performance and turbidity data for three membrane-coated cross-flow filtration devices prepared according to Example 2 and evaluated in the filtration tests of Example 3.

FIG. 5 is a graph illustration comparing the filtration flux of the cross-flow filtration device prepared from Example Ito that prepared from Example II when measured under a constant trans-membrane pressure (TMP).

FIG. 6a is a graph illustration of the effect of channel size on the flux of clean water. FIG. 6b is a graph illustration of an exemplary influence of channel size reduction on relative flux according to embodiments of the disclosure.

FIG. 7 schematically illustrates the accumulation of filtered particles forming a filtration cake layer during a membrane separation process.

### DETAILED DESCRIPTION

Low surface area packing density and high cost per unit surface area have been major barriers that hinder widespread use of inorganic cross-flow filtration devices in liquid membrane separation processes. To that end, monolith-type modules with an array of parallel membrane channels embedded in or formed from a porous solid body, typically in a cylindrical form, have been used as membrane supports for such applications. This general design advantageously offers a higher surface area and packing density than single-channel tubes of the same diameter. However, it is known that particulate retained by the membrane tends to form a filtration cake layer over time. The filtration cake layer may add flow resistance to the permeation process. In addition to surface area packing density, the channel size and shape also affect hydrodynamics and mass transfer for an actual filtration process, and thus, thickness and structures of the filtration cake layer. Embodiments of the invention disclosed in the present disclosure having small channels with round diameters shape provide solutions to these problems.

Various embodiments of the disclosure will be described in detail with reference to drawings. Reference to various embodiments does not limit the scope of the disclosure. Additionally, any examples set forth in this specification are not limiting and merely set forth some of the many possible embodiments of the invention.

The following descriptions of embodiments of the invention are provided. To this end, those skilled in the relevant art will recognize and appreciate that many changes can be made to the various embodiments of the invention described herein, while still obtaining the beneficial results of embodiments of the present invention. It will also be apparent that some of the desired benefits of embodiments can be obtained by selecting some of the features of the embodiments without utilizing other features. Accordingly, those who work in the art will recognize that many modifications and adaptations are possible and can even be desirable in certain circumstances and are a part of the present invention. Thus, the following description is provided as illustrative of the principles of the present invention and not in limitation thereof.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Reference will now be made in detail to embodiments of the invention, examples of which are illustrated in the accompanying drawings. It should be noted however that the drawings are not necessarily drawn to scale.

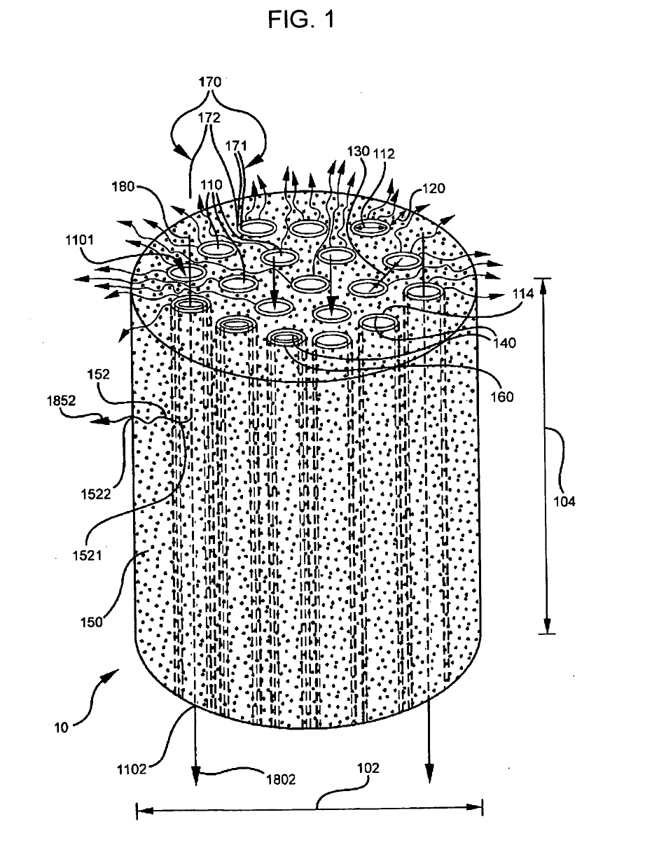

Referring to FIG. 1, a monolithic multi-channel cross-flow filtration substrate 10 is shown having a porous monolithic body or module 150 defining a plurality of flow channels 110 disposed in the body and extending along the length of the substrate from an upstream inlet or feed end 1101 to a downstream outlet or exhaust end 1102. Porous channel walls 114 surround each of the plurality of flow channels 110. The porous body 150 further comprises a networked pore structure of interconnected pores forming torturous fluid paths or conduits 152. The tortuous paths 152 formed by the porous body 150 provide a flow path for directing filtrate separated from a process stream to an exterior surface of the body. In use, the plurality of flow channels can receive a process stream and the porous channel walls can subsequently separate at least a portion of the received process stream into a filtrate and a retentate whereby the separated filtrate is directed through the networked pore structure, or tortuous paths 152, to an exterior surface of the body. Because a portion of the feed stream flows through the substrate from an inlet end to an outlet end through the channels to form a retentate, and a portion of the feed stream flows across the substrate, through the interconnected pores of the substrate itself to collect as the filtrate, the device is called a cross-flow filtration device. The Embodiments of the cross-flow filtration device, as exemplified in the following description, can be used for liquid-phase separation in laboratory scale or in commercial scale, for extraction of one or more components from a fluid process stream.

The monolithic body 150 can have any desired predetermined size and shape. For example, although the body or module 150 is exemplified as a cylinder with a substantially circular cross-section in FIG. 1, it should be understood that the module 150 can be shaped to provide any elliptical or polygonal cross-section. To that end, exemplary and non-limiting monolith cross-sectional shapes or device cross-sectional perimeters include ellipses, ovals, circles, rectangle, square, pentagonal, hexagonal, octagonal, and the like. For consistency and simplicity, the cylindrical form of the module body 150 has been used primarily in the subsequent discussions.

As used herein, the term hydraulic diameter (Dₕ) of a particular geometric element is defined by the following formula: Dₕ=4[cross-sectional area (CSA) of the geometric element/cross-sectional perimeter (CSP) of the geometric element]. Thus, for a two-dimensional shape, the hydraulic diameter is 4 times the surface area divided by the perimeter. For example, for a circle of diameter “d”, the hydraulic diameter Dₕ=4[(πd²/4)]/(πd). However, for a square of length L, hydraulic diameter Dₕ=4×L²/(4 L). In general, it should be understood that a hydraulic diameter bears an inverse relationship to the surface to volume ratio.

In embodiments, the body 150 has a module hydraulic diameter 102 in a range about 10 to 200 mm. In embodiments, the body 150 has a module hydraulic diameter 102 greater than about 10 cm. As used herein, the hydraulic diameter 102 of the body or module 150 refers to the hydraulic diameter of the total module frontal area. The total module frontal area is the cross-sectional area of the module body that includes the solid matrix of porous material and the plurality of flow channel openings. For example, for a cylindrical body or module of diameter d, the total module frontal area is πd²/4.

The body 150 also has an aspect ratio of the module length 104 to the module hydraulic diameter 102 that is greater than 1. In some embodiments, the aspect ratio is greater than 3. In still other embodiments, the aspect ratio is greater than 5. For example, the module length 104 may be 30 mm while the module hydraulic diameter may be 5 mm, having an aspect ratio of 6. In embodiments, the module length 104 may be greater than 10 cm, greater than 20 cm, greater than 30 cm, or greater than 40 cm.

The plurality of flow channels 110 may be distributed in parallel and symmetrically over the module cross-section. The flow channels also extend from the module upstream inlet end 1101 to the module downstream outlet end 1102, forming a pathway through which a desired process stream can pass. In the exemplified embodiment, the flow channel cross-sectional shape is circular or rounded. However, it should be understood that the flow channel cross-section shape can be any desired elliptical or polygonal shape this is continuous and which preferably has substantially no sharp corners. Exemplary channel cross-sectional shapes include ellipses, circles, rectangle, square, pentagonal, hexagonal, octagonal, and the like.

In embodiments, the plurality of flow channels are sized and shaped to provide a channel hydraulic diameter 112 that is not greater than 1.8 mm. Similar to the calculation of the module or body hydraulic diameter, the channel hydraulic diameter is determined according to the equation: Dₕ=4[cross-sectional area (CSA) of the flow channel/cross-sectional perimeter (CSP) of the flow channel]. Thus, for a two-dimensional shape, the hydraulic diameter of the flow channel is 4 times the surface area divided by the perimeter. For example, for the substantially cylindrical flow channels exemplified in FIG. 1 having a diameter d, the channel hydraulic diameter Dₕ=4[(πd²/4)]/(πd). According to embodiments of the disclosure, the plurality of flow channels preferable have a hydraulic diameter in the range of from 0.5 mm to 1.8 mm, including exemplary values of 0.6 mm, 0.7 mm, 0.8 mm, 0.9 mm, 1.0 mm, 1.1 mm, 1.2 mm, 1.3 mm, and 1.4 mm or having a hydraulic diameter less than or equal to 1.8 mm, less than or equal to 1.5 mm, less than or equal to 1.25 mm, less than or equal than or equal to 1.1 mm, less than or equal to 1.0 mm or less than or equal to 0.9 mm. In still other embodiments, the channel hydraulic diameter can be in a range derived from any two of the above-mentioned exemplary hydraulic diameter values. For example, in still other embodiments, the channel hydraulic diameter can be less than or equal to 1.1 mm such as, for example, in the range of from 0.5 mm to 1.1 mm.

In additional embodiments, the plurality of flow channels 110 are further sized and shaped to provide a flow channel density such that the open frontal area (OFA) fraction of the module 150 is in the range of from 20% to 70%. The open frontal area fraction is the ratio of overall open channel areas to the total module frontal area. For example, for an exemplary module having a total frontal cross-sectional area of 10 cm², if the total open channel area is 5 cm², then the open frontal area fraction is 5 cm²/10 cm² or 50%, where the total open channel area is the sum of cross-sectional areas for all of the channels. In an exemplary and non-limiting embodiment, the plurality of flow channels 110 define a channel density in the range of about 50-800 channels/in² (7.8-124 channels/cm²) in a module frontal area.

The flow channels are preferably distributed over the module cross-section symmetrically but may not need to be distributed uniformly. Even though the channel distribution is shown uniform in FIG. 1, the flow channels 110 can be distributed within the module in non-uniform ways. In an embodiment, the flow channels are substantially parallel. However, depending upon the geometry of the module, flow channels may not follow a straight course, and may not be parallel. For example, if there is sufficient web thickness where there would not be an overlap or intersection of non-aligned channels, the channels 110 can even be skewed (having a skewed angle less than 90°) in a non-parallel distribution. For a non-uniform channel distribution, the web thickness 130 will be in a range of different thicknesses (for example, about 0.2 to about 2 mm). But, it is preferred to have an adequate skin thickness (e.g., >1 mm or 0.04 inch) in the rim 120 greater than the web thickness 130. The skin or rim thickness 120 is an independent parameter from the web thickness 130. The web thickness 130 is a measure of the distance between channels 110, while the skin or rim thickness 120 is a measure of the distance from the outside channel to the outer surface of the module, and affects the overall module strength and permeability.

In embodiments, the monolithic body 150 can be formed from any suitable porous material including inorganic or organic materials, or combinations or composites of organic-inorganic material. In some embodiments, the monolithic body can for example be comprised of a polymeric material. In embodiments, the polymeric material may be, for example, polysulfone, polyacylonitrile, polyvinylidenefluoride, or polyolefin. In other embodiments, the monolithic body can be comprised of metallic or ceramic materials. In an embodiment, the monolithic body is comprised of a porous ceramic material. For example, and without limitation, in some embodiments the porous monolith body 150 is made from a ceramic composition selected from mullite (3Al₂O₃-2SiO₂), alumina (Al₂O₃), silica (SiO₂), cordierite (2MgO—2Al₂O₃-5SiO₂), silicon carbide (SiC), alumina-silica mixture, glasses, inorganic refractory materials and ductile metal oxides. In another embodiment, the monolith body 150 is comprised of a porous ceramic mullite, such as the mullite compositions disclosed and described in U.S. Pat. No. 6,238,618, the entire disclosure of which is incorporated by reference herein.

As noted above, the porous material which forms the module or body 150 is comprised of an interconnected matrix or network of pores which forms a networked plurality of tortuous fluid paths or conduits 152. The fluid conduits 152 are capable of directing separated filtrate that has permeated the flow channel walls to an exterior surface of the body 150 for subsequent collection or processing. According to embodiments of the disclosure, the total pore volume or porosity % P of the ceramic monolith is in the range of from 20% to 60%, including exemplary porosity values of 25%, 30%, 35%, 40%, 45%, 50% and 55%. Still further, the total porosity of the ceramic monolith can also be within a range derived from any two of the aforementioned porosity values.

In embodiments, the pore volume of the monolithic body 150 has pores having pore diameter sizes in the range of from 2 μm to 20 μm, including exemplary pore diameter sizes of 3 μm, 5 μm, 7 μm, 9 μm, 11 μm, 13 μm, 15 μm, 17 μm, and even 19 μm. Still further, the total porosity of the monolithic body can be in a range derived from any two of the above mentioned porosity values.

The pore size and total porosity % P are values that can be quantified using conventionally known measurement methods and models. For example, the pore size and porosity can be measured by standardized techniques, such as mercury porosimetry and nitrogen adsorption.

The module or body 150 can be prepared by any conventionally known casting or extrusion methods. For example, the module or body can be comprised of a sintered ceramic composition having mullite as its primary phase. The sintered ceramic can be prepared from an extrudable plasticized batch composition comprised of ceramic forming raw materials, an organic binder system, and an optional liquid vehicle. The extrudable mixture can be extruded to form a green body of the desired configuration. The green body can be dried and fired for a time and at temperature sufficient to form a sintered ceramic structure. The filtrate conduits can be formed in the monolith, for example, at the time of manufacture by extrusion or by other means after extrusion. Exemplary plasticized batch compositions and manufacturing processes for preparing the monolithic structures of the instant disclosure are those disclosed and described in U.S. Pat. No. 6,238,618, the entire disclosure of which is incorporated by reference herein.

For processing fluid streams in applications such as coarse microfiltration, extraction, fluid mixing, and the like, the porous monolith body 150 can be used by itself in the absence of an added membrane layer. However, for other fluid stream processing applications, a porous membrane can be deposited on at least a portion of the porous flow channel walls.

If desired, an optional intermediate layer 160 of porous materials that may have smaller pore sizes than the pores of the monolith matrix can be deposited onto the channel wall 114 of the substrate or matrix body portion 150 and can be used alone or with a membrane film 140. In embodiments, these layers, 160 and 140, may be referred to as membranes, coatings, films, coating layers or coating films. The coating layer 160 can serve one or more possible functions. In some embodiments, the coating 160 can be applied to modify the flow channel shape and wall texture, including such parameters as pore size, surface smoothness, and the like. In other embodiments, the coating layer 160 can be used to strengthen the monolithic body 150. In still further embodiments, the coating layer 160 can be used to enhance the membrane deposition efficiency and adhesion.

In embodiments, the porous coating layer 160 may be deposited such that it exhibits a layer thickness in the range of from about 5 to 150 μm. Further, the pore volume of the optional coating layer 160 may be comprised of pore sizes in the range of from 2 nm to about 500 nm. In embodiments, the porous coating layer has a total pore volume % P having pores having an average pore size diameter of less than 200 nm. Thus, one or more intermediate porous coating layers 160 can optionally be disposed on the inner surfaces or walls 114 of the plurality of feed flow channels 110 to form a nano- or meso-porous layer.

In embodiments, the optional layer 160 may be comprised of a material selected from the group consisting of alumina, silica, mullite, glass, zirconia, titania, or a combination of any two or more thereof. In an additional embodiment, the intermediate layer 160 is comprised of alumina, zirconia, silica or titania. The intermediate coating layer 160 may be applied by conventionally known wet chemistry methods such as a conventional sol-gel process.

Optionally, an additional membrane film 140 providing a separation function can be further applied onto the optional intermediate coating layer 160 or directly on the inner surfaces or walls 114 of the plurality of feed flow channels 110 of the monolithic body 150. To that end, because the layer 160 can be used alone, without another layer, the term “membrane” as used herein refers to embodiments comprising the use of the layer 160 alone, use of the layer 140 alone, or the use of both layers 140 and 160. Multiple layers of membrane may be present. The membrane 140 can be comprised of inorganic or organic materials. For example, in some embodiments, the membrane film 140 can be a dense layer, or a non-metallic dense film that allows permeation of certain molecules in a mixture, such as SiC, or glass. In still other embodiments, the membrane film 140 can be a micro-porous layer comprised of, for example, zeolite, zirconia, alumina, silica, titania, or glass. These exemplary microporous membrane materials can be used to provide a separation function in the molecular size level. In still further embodiments, the membrane layer 140 can be a polymeric membrane film. When present, the porous membrane layer 140 is preferably deposited such that it exhibits a layer thickness in the range of from about 1 to 20 μm. Further, the pore volume of the optional additional membrane layer 140 is preferably comprised of pore sizes less than about 200 nm.

In embodiments, the substrate can be used for separating, purifying, filtering, or other processing functions for a variety of liquid-phase mixtures through a plurality of tortuous paths 152 through the matrix of the porous body portion 150 having membraned sections 1521 and a non-membraned porous body sections 1522. In general, the concept of tortuosity, is defined as the difference between the length of a flow path which a given portion of a fluid or a mixture of fluids will travel through the passage formed by the channel as a result of changes in direction of the channel and/or changes in channel cross-sectional area versus the length of the path traveled by a similar portion of the mixture in a channel of the same overall length without changes in direction or cross-sectional area, in other words, a straight channel of unaltered cross-sectional area. The deviations from a straight or linear path, of course, result in a longer or more tortuous path and the greater the deviations from a linear path the longer the traveled path will be.

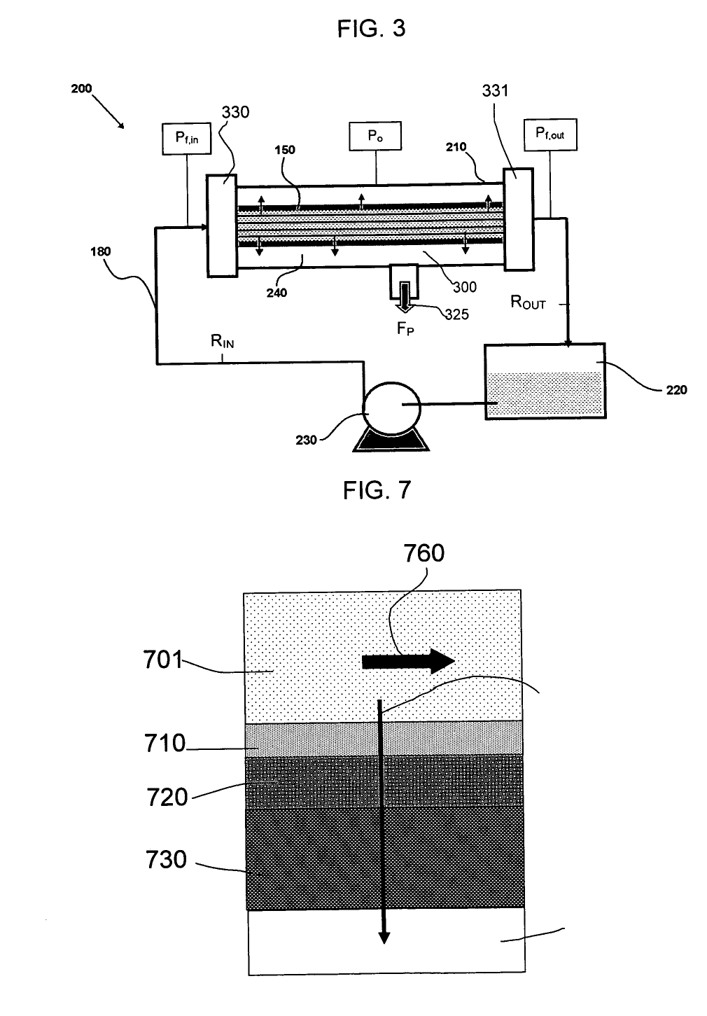

In embodiments, the membrane module 10 has a structure that in use can be placed vertically as shown in FIG. 1, laid horizontally as shown in FIG. 3, in a slant, or aligned in any other position. Each of the feed flow channels 110 has an upstream inlet or feed end 1101 and a downstream outlet end 1102. The membrane films 160 and 140 are supported and adapted to receive under a positive pressure gradient 170, an impure mixed feedstream 180 fed on the feed end 1101 of the plurality of flow channels 110. The positive pressure gradient 170 consists of first pressure drop 171 across the membrane 140 and optional intermediate coating layer 160 and a second pressure drop 172 through the porous monolithic body 150. The membrane films 160 and 140 is adapted to process the impure mixed feedstream 180 into a purified filtrate or permeate 1852 that is formed from a portion of the impure mixed feedstream 180 that passes through an outside surface of the membrane film 140 and into the plurality of tortuous paths 152 of the matrix of the body portion 150, entering the membraned section 1521 and exiting through the non-membraned porous body section 1522. A byproduct or retentate stream 1802 remains from a portion of the impure mixed feedstream 180 that does not pass through the membrane films 160 and(or) 140 (if present) and exits through the outlet end 1102 of the plurality of feed flow channels 110.

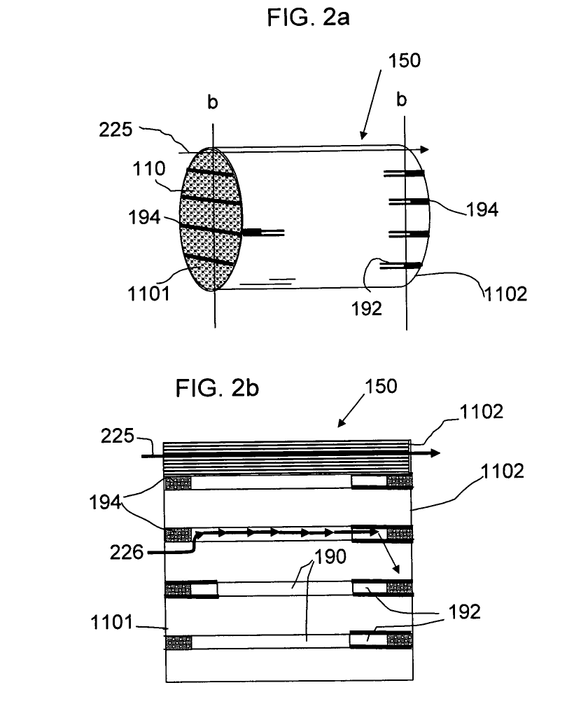

With reference to FIGS. 2a and 2b, in additional embodiments, the monolith 150 may contains flow channels 110 as shown in FIG. 2a and illustrated in part of FIG. 2b, and one or more filtrate conduits 190 formed within the monolith 150 as shown in FIGS. 2a and 2b. Filtrate conduits are special flow channels structured and arranged to provide a pathway for filtrate material to flow through the interior of the monolith in a separate stream from retentate material.

In some embodiments, the filtrate conduits 190 may extend longitudinally from the upstream inlet or feed end to the downstream outlet or exhaust end of the structure. Alternatively, at least one of the filtrate conduits can extend longitudinally with the one or more flow channels along at least a portion of its length. As further shown in FIG. 2, the filtrate conduit can include a channel or slot 192 extending transversely from the longitudinal portion to a filtrate collection zone for directing filtrate to the external surface of the monolith 150 or to a filtrate collection zone (see 300, FIG. 3). The filtrate conduit may further include a plurality of longitudinal chambers which connect with the channel. The slot 192 may be an opening, slot or channel at an end of the monolith or a hole formed in the monolith to connect the longitudinal portion of the filtrate conduit to the filtrate collection zone 300 (see FIG. 3). In embodiments, at least one slot may be formed in the filtrate conduit or slots may be formed at both the feed end and the outlet end of the device. Or, slots 192 may be holes introduced through the exterior surface of the monolith body at any point along the length of the monolith. The filtrate conduits 190 may be blocked at the feed end and the outlet end by barriers 194. Barriers 194 inhibit direct passage of the process stream into or out of the filtrate conduits at the feed end or the outlet end of the monolith. The barrier 194 may be plugs of material, inserted or introduced into the filtrate conduit 190. The barrier 194 may be made from the same material as the structure, or other suitable material, and the plugs may have a porosity similar to or less than that of the structure material.

In embodiments of the present invention, which provide filtrate conduits 190, blocked at both a feed end 1101 and an outlet end 1102 with barriers 194, received process stream enters the monolith 150 at the inlet end 1101 of the monolith. A portion of the received process stream, the retentate, flows through the monolith 150 through flow channels 110, to the exit end 1102 as shown by arrow 225 in FIGS. 2a and 2b. A portion of the received process stream, the filtrate, enters the monolith through flow channels 110, flows through the networked pore structure of the monolith 150, to a filtrate conduit 190, imbedded in the monolith structure. The filtrate conduits 190 are flow channels which are blocked at both ends by barriers 194, and which are open to the side of the monolith through slots or exit pathways 192 to allow filtrate to flow through the porous structure of the monolith, to filtrate conduits to the exterior of the monolith. Because the filtrate conduits 190 are blocked at both ends, they form low pressure pathways within the monolith structure. The fraction of the process stream that enters the pores of the monolith structure flow to this low pressure pathway through the pores of the material, and then exits the monolith through the slots or exit pathways 192, in a filtrate collection zone 300 (see FIG. 3) which is separate from the outlet end of the monolith, from which the retentate is collected. In this way, the process stream is separated into a retentate, which flows through the monolith from the inlet end to the exit end through flow channels 110, and a filtrate which flows into the monolith, enters the pore structure of the porous material, flows into a filtrate conduit 190, and exits the monolith through slots 192 in the side of the monolith 150 (as shown by the arrows 226 in FIG. 2b). The filtrate conduits 190 provide pathways having a low flow resistance compared to the flow channels, creating a pressure drop that allows filtrate to flow through the networked pore structure of the monolith to the filtrate conduits 190. The filtrate conduits are blocked by barriers 194 to an exterior surface of the monolith body.

The filtrate conduits 190 provide flow paths of lower flow resistance than that of flow channels 110 through the porous material, and the structure is constructed such that the filtrate conduits are distributed among the passageways to provide low pressure drop flow paths from the passageways through the porous material to nearby filtrate conduits. The plurality of filtrate conduits can carry filtrate from within the structure toward a filtrate collection zone 300 (see FIG. 3) disposed about the exterior surface of the monolithic body or module 150. Exemplary discrete filtrate conduits 190 are for example disclosed and described in U.S. Pat. No. 4,781,831.

In embodiments, filtrate conduits 190 may be absent (as shown in FIG. 1) or present (as shown in FIGS. 2a and 2b). In general, monolith substrates having smaller module hydraulic diameters (for example less than about 50 mm) provide adequate filtration without incorporating filtrate conduits 190. Larger substrates may require filtrate conduits in order to facilitate the removal of filtrate fluids from the internal portions of the larger substrate.

In some embodiments, it is also contemplated that the porous monolithic substrates of the disclosure specifically do not define a discrete conduit for receiving a second stream of fluid, separate from the process or fluid stream, for example a purge stream. Such exemplary discrete conduits for receiving a purge stream are described and disclosed in U.S. Pat. No. 7,169,213. For example, it is surprisingly found that embodiments of the present invention operate favorably without the need for a second fluid stream, introduced to the monolith through a discrete purge stream conduit, flowing through the monolith to act as a purge stream or a sweep stream to force the flow of filtrate through the monolith body, into the filtrate conduits 190, and out of the monolith through the slots 192. This feature, a separate fluid stream to sweep the filtrate through the monolith body, is an example of a feature that may be necessary to allow a larger diameter part, larger in diameter than, for example, 5 cm, 10 cm, 15 cm or 20 cm, to operate in the absence of slots 192.

In use, the cross-flow filtration device can be used for separation processes wherein the mixed feedstream 180 is a liquid-phase stream, such as a water-based solution containing other larger components. The larger components can be larger molecules and/or particulates. Thus, a water mixture can have finely-dispersed oil droplets from an industrial waste water stream. Water mixtures can have particulates such as in a beverage juice. Water mixtures can have macro molecules such as proteins. Embodiments of the cross-flow filtration device are appropriate for separation processes with water as the permeate, because water as the smallest molecule the liquid mixture would have a larger permeability through the substrate matrix than the other components. Moreover, the cross-flow filtration device is also particularly preferred for separation processes of liquid mixtures involving organic solvents where the organic solvent is the permeate. The liquid-phase stream could be an organic solvent-based solution containing other larger components.

For a body 150 having a given monolith hydraulic diameter and open frontal area fraction, the surface area packing density of the module increases with decreasing channel size. Thus, the use of the small-sized flow channels having channel hydraulic diameter less than or equal to 1.1 mm facilitates an increase in the surface area packing density of the module. However, it was surprisingly found as exemplified in the following examples, that reducing the channel size not only enhances the surface area packing density but also substantially increases permeation flux, which can be translated to substantial increase in the filtration throughput represented by the permeation rate per unit volume of the membrane module.

It will be apparent to those skilled in the art that various modifications and variations can be made to the described embodiments to include processing applications, such as sensors, without departing from the spirit and scope of the invention. Thus it is intended that the present invention include modifications and variations of the described embodiments.

### EXAMPLES

To further illustrate embodiments, the following examples are put forth so as to provide those of ordinary skill in the art with a description of how embodiments of the cross-flow filtration device are made and evaluated. They are intended to be purely exemplary of the invention and are not intended to limit the scope of what the inventors regard as their invention. Unless indicated otherwise, parts are parts by weight, temperature is ° C. or is at ambient temperature, and pressure is at or near atmospheric.

### Example 1

### Comparative Monolithic Body

A comparative cylindrical monolith support was prepared by a conventional extrusion process utilizing a circular extrusion die. The comparative cylindrical monolith had a hydraulic diameter of about 1.08 inches and a module length of 12 inches. The module comprised 60 square flow channels having a channel width of 1.85 mm. The flow channels were uniformly distributed over the cross-sectional area of the module. The resulting module had a surface area of 1.46 ft² (0.135 m²) and an open frontal area of 205.4 mm². The comparative monolith did not have slots or filtrate conduits.

The monolith support was formed of a porous mullite material having a mean pore size of about 4.5 μm and total porosity of about 40%. The surface of the flow channel walls were first pre-coated with a mixture of zircon and alpha-alumina followed by a layer comprised of a mixture of alpha-alumina and zirconia to provide an intermediate porous coating. The resulting intermediate porous coating was comprised of a mean pore opening in the range of about 50 to 200 nm. A top layer coating of titania was finally applied to provide an outer membrane layer having a mean pore opening of about 10 nm.

### Example 2

### Experimental Monolithic Body

An experimental cylindrical monolith support (a cross-flow filtration device according to embodiments of the present invention) was prepared by an extrusion process utilizing a circular extrusion die. The experimental cylindrical monolith had a hydraulic diameter of about 9.7 mm and a module length of 133 mm. The module comprised 19 rounded flow channels each having a channel diameter of 0.88 mm. The flow channels were uniformly distributed over the cross-sectional area of the module. The resulting module had a surface area of 0.0070 m² and an open frontal area of 11.61 mm². In this embodiment, the experimental monolith did not have slots or filtrate conduits.

The experimental monolith support was formed of a porous mullite material having a mean pore size of about 4.5 μm and total porosity of about 40%. The surface of the flow channel walls were first pre-coated with a mixture of zircon and alpha-alumina followed by a layer comprised of a mixture of alpha-alumina and zirconia to provide an intermediate porous coating. The resulting intermediate porous coating had a mean pore opening in the range of about 50 to 200 nm. A top layer coating of titania was finally applied to provide an outer membrane layer. In this manner, three membrane coated monolithic bodies were prepared having top layer membrane coatings with pore openings of about 200 nm, 50 nm, and 10 nm respectively.

### Example 3

### Filtration Testing

Utilizing comparative and experimental monolithic bodies prepared according to Examples 1 and 2 above, filtration testing was conducted over a cross-flow filtration apparatus 200 as schematically illustrated in FIG. 3. A paint and water mixture was used as the process stream 180. These paints contained paint particles ranging in size from about 20 nm to about 3 μm at solids concentration of about 20.5 weight % solids. The commercially available paint was obtained from PPG Industries, Pittsburgh, Pa.

For each filtration test, for both the comparative and the experimental monolithic, membrane body 150 was housed in a vessel 210, as shown in FIG. 3, having end caps, an inflow end cap 330 and an outflow end cap 331. The paint/water mixture was stored in a tank 220 from where it was continuously pumped by pump 230 into the vessel 210 and through the membrane channels of the monolithic body 150. Retentate, fluid that was not filtered through the channels and through the monolith, flowed out of the apparatus shown in FIG. 3 through the outflow end cap 331. Retentate may be re-circulated and re-filtered. The pressure inside the membrane channel was maintained at a higher value than that in the annular space 240 surrounding the exterior of the membrane body. As a result, the water permeated through the membrane and through the porous monolithic body, as shown by the small arrows, where it was collected in the annular space surrounding the exterior surface of the monolithic body 150, the filtrate collection zone 300, and out of the apparatus as permeate (Fp) shown by the large arrow. The particles in the feed stream were blocked from flowing through the porous structure of the monolithic body by the membrane coating layer. The permeation flow rate for each filtration test was measured and recorded. The NTU (Nephelometric Turbidity Unit) of the permeate was also measured using a nephelometer.

Flux values were calculated according to the following equation:

$$Flux = \frac{{F}_{P}}{{SA}_{m}}$$

where “Fₚ”=Permeation flow rate and “SA_{M}”=Membrane surface area.

Permeance was calculated by the following equation:

$$Permeance = \frac{Flux}{{TMP}_{avg}}$$

where “TMP_{avg}”=Average trans-membrane pressure as calculated by the equation:

$${TMP}_{avg} = \frac{{P}_{F , in} + {P}_{F , out}}{2} - {P}_{0}$$

where “P_{F,in}”=Inlet pressure; “P_{F,out}”=Outlet pressure; and Pₒ=Pressure on the permeation side.

The Cross-flow linear velocity was calculated by the following equation:

$$V = \frac{{R}_{in}}{{SA}_{open}}$$

where “Rᵢₙ”=Cross-flow rate and “SAₒₚₑₙ”=Total cross-sectional area of open channels.

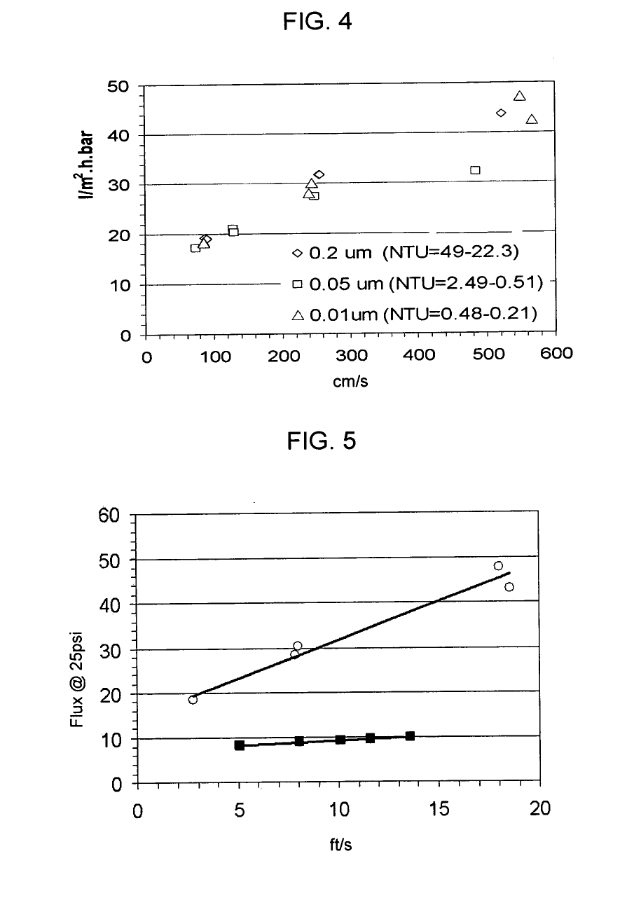

Based upon the filtration test procedures described above, FIG. 4 illustrates the filtration performance. Permeance (I/m².h.bar) on the Y axis is plotted against cross-flow linear velocity (cm/s) on the Y axis. Performance and turbidity data for the three experimental membrane coated monolithic bodies prepared according to Example 2 above. It can be seen that the permeance values for all three membranes were similar and increased with increasing cross flow linear velocity. However, the permeate resulting from the membranes having smaller pore size openings provided greater reduction in permeate turbidity as reflected by lower NTU values. In particular, the membrane having pore openings of about 200 nm (0.2 μm), as illustrated by the diamond shown in FIG. 4, provided NTU values in the range of 49-22.3 whereas the membrane having pore openings of about 50 nm (0.05 μm) (shown by the squares in FIG. 4) and about 10 nm (0.01 μm) (shown by the triangles in FIG. 4) provided NTU values of 2.49-0.51 and 0.48 to 0.21, respectively. In contrast, the NTU value of the untreated paint/water mixture feed was greater than 1000 (data not shown).

FIG. 5 illustrates flux, measured as gallons/ft²/day at 25 psi on the Y axis vs. cross-flow velocity in the channels, measured in ft/s on the X axis. The flux of the comparative membrane prepared from Example 1 (1.8 mm square channels, the comparative example, shown as squares in FIG. 5) to that prepared from Example 2 (0.88 mm rounded channels, an embodiment of the experimental module, shown as circles in FIG. 5) when measured under a constant trans-membrane pressure (TMP) (25 psi). The same support and membrane materials were used so the only difference was the channel size and shape. It can be seen that the flux for the 0.88 mm channel increases proportionally with the cross flow linear velocity, while the flux for the 1.8 mm channel only increases slightly with cross-flow linear velocity. At the same cross flow linear velocity, the flux for the smaller channel is about two to three times that of the large channel.

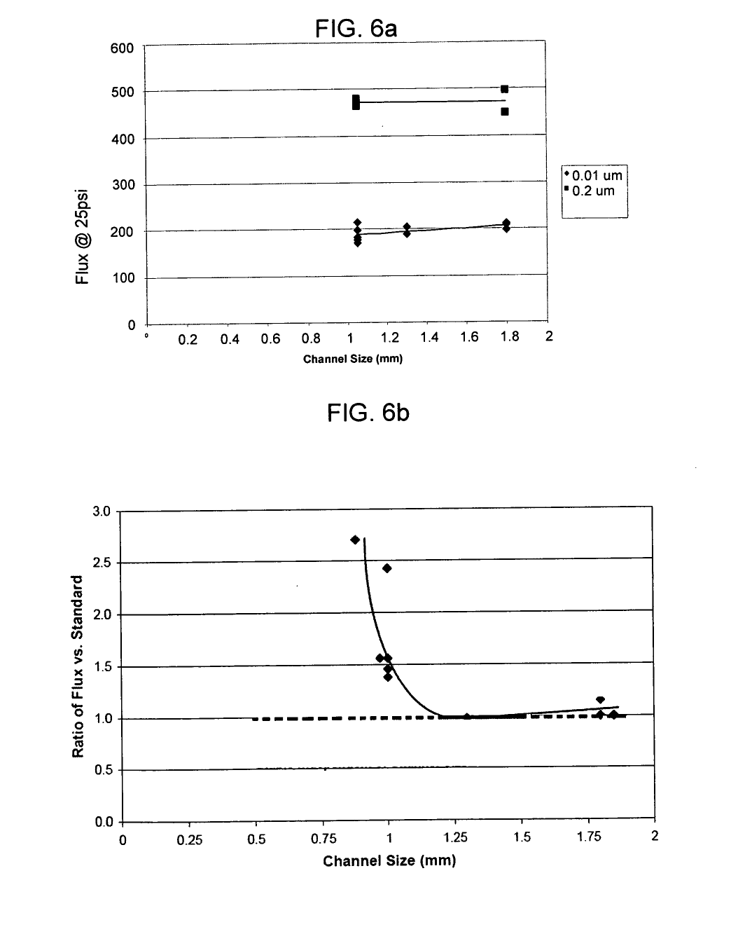

Still further, it was expected that process flux (flow normalized to membrane surface area) on the paint test would be independent of membrane channel size and, as such, throughput flow would be strictly proportional to membrane surface area. FIG. 6a shows clean water flux (GFD) at 25 psi on the Y axis against channel size (mm) on the X axis. The flux of clean water through experimental monoliths of Example 2, having membranes with pore sizes of 0.01 μm (diamonds on FIG. 6a) and 0.2 μm (squares on FIG. 6a) at a pressure of 25 psi was not affected by changes in channel size (diameter). However, contrary to this expectation, a surprising result was seen when evaluating the impact of channel diameter on flux levels normalized to the flux level of a standard 1.8 mm square channel part. In particular, as shown in FIG. 6b, an exponential increase in flux (shown as a ratio of Flux vs Standard) was observed once channel size declined below 1.3 mm in diameter, with the maximum increase in flux shown below about 1.1 mm in diameter. This result is surprising in light of the expected performance, shown by the dashed line in FIG. 6b, where flux would remain stable, independent of channel size.

Without intending to be bound or limited by theory, it is believed that the difference in the filtration performance between two different sizes of membrane channels may be explained by difference in the filtration cake layer. As schematically illustrated in FIG. 7, fluid 701, flows through the channels of an embodiment of a monolith of the present invention, as shown by the large arrow 760. As filtrate passes across the porous membrane 720, into the porous monolith body 730, and out into a filtrate collection zone 300, retained particles tend to accumulate on the membrane channel surface to form a filtration cake layer 710. The filtration cake layer 710 can add significant flow resistance to the permeation, which can dominate the flow resistance through the membrane coating layer itself, as evidenced by the data shown in FIG. 6. The thickness and density of the filtration cake layer could be affected by the hydrodynamics and mass transfer inside the flow channel. To that end, it is believed that reducing the channel size may reduce the thickness of the resulting filtration cake layer, thus making flow characteristics more dynamic rather than stagnant, resulting in the surprising result that a smaller diameter channel creates a module with improved flux characteristics.

1. A cross-flow filtration device for receiving a process stream and for separating the process stream into a filtrate and a retentate, the device comprising:
a porous monolithic substrate defining a plurality of flow channels bounded by porous channel walls and extending from an upstream inlet end to a downstream outlet end through which a portion of the process stream flows, wherein the plurality of flow channels have a cross sectional area (CSA), a cross sectional perimeter (CSP), where Dₕ=4[(CSA)/(CSP)]; and
a porous membrane deposited on at least a portion of the plurality of porous flow channel walls;
at least one filtrate conduit to direct separated filtrate to a filtrate collection zone;
wherein the channel hydraulic diameter Dₕ is less than or equal to 1.10 mm; and,
wherein the porous monolithic substrate does not have a discrete conduit for receiving a purge stream.

2. The cross-flow filtration device of claim 1, wherein the porous monolithic substrate has a module hydraulic diameter greater than 10 cm.

3. The cross-flow filtration device of claim 1, wherein the porous monolithic substrate has an aspect ratio of greater than 1.

4. The cross-flow filtration device of claim 1 wherein the porous membrane is an inorganic layer.

5. The cross-flow filtration device of claim 1 wherein the porous membrane is a polymer layer.

6. The cross-flow device of claim 1 wherein the porous monolithic substrate has a module length greater than 30 cm.

7. The cross-flow filtration device of claim 1, wherein the channel hydraulic diameter Dₕ, is in the range of from 0.5 mm to 1.10 mm.

8. The cross-flow filtration device of claim 1, wherein the channel hydraulic diameter Pₕ is less than 0.9 mm.

9. The cross-flow filtration device of claim 1, wherein the porous monolithic substrate has a total pore volume % P in the range of from 20% to 60%.

10. The cross-flow filtration device of claim 1, wherein the porous monolithic substrate has a total pore volume % P comprised of pores having a pore size diameter in the range of from 2 μm to 20 μm.

11. The cross-flow filtration device of claim 1, wherein the porous membrane has a total pore volume % P comprised of pores having an average pore size diameter less than 200 nm.

12. The cross-flow filtration device of claim 1, wherein the upstream inlet end of the porous monolithic substrate has an open frontal area in the range of from 20% to 70% of the upstream inlet end total area.

13. The cross-flow filtration device of claim 1, wherein the porous monolithic substrate comprises an inorganic material.

14. The cross-flow filtration device of claim 13, wherein the porous monolithic substrate comprises a ceramic material.

15. The cross-flow filtration device of claim 14, wherein the porous monolithic substrate comprises mullite.

16. The cross-flow filtration device of claim 1, wherein the porous monolithic substrate comprises an organic material.

17. The cross-flow filtration device of claim 16, wherein the porous monolithic substrate comprises a polymeric material.

18. The cross-flow filtration device of claim 1, wherein the membrane comprises a composite organic-inorganic material.

19. The cross-flow filtration device of claim 1, wherein the cross-sectional area of the plurality of flow channels is round.

20. The cross-flow filtration device of claim 1, wherein the device is cylindrical.

21. The cross-flow filtration device of claim 1, wherein cross-sectional perimeter is oval.

22. The cross-flow filtration device of claim 1, wherein the process stream is liquid.

23. A cross-flow filtration device for receiving a liquid process stream and for separating the process stream into a filtrate and a retentate, the device comprising:
a porous monolithic substrate defining a plurality of flow channels bounded by porous channel walls and extending from an upstream inlet end to a downstream outlet end through which a portion of the process stream flows, wherein the plurality of flow channels have a cross sectional area (CSA), a cross sectional perimeter (CSP);
a channel hydraulic diameter Dₕ less than or equal to 1.1 mm, where Dₕ=4[(CSA)/(CSP)];
a porous membrane deposited on at least a portion of the plurality of porous flow channel walls;
the porous monolithic substrate has a module length greater than 30 cm;
wherein the porous monolithic substrate does not define conduits for directing separated filtrate; and,
wherein the porous monolithic substrate does not have a discrete conduit for receiving a purge stream.

24. The cross-flow filtration device of claim 23, wherein the channel hydraulic diameter Dₕ is in the range of from 0.5 mm to 1.1 mm.

25. The cross-flow filtration device of claim 23, wherein the channel hydraulic diameter Dₕ, is less than 0.9 mm.
